(19) United States
(12) Patent Application Publication
(10) Pub. No.: US 2013/0018290 A1
(43) Pub. Date: Jan. 17, 2013

(54) Method and apparatus for appendage massage

(71) Applicant: John Holdorf, Corvallis, OR (US)

(72) Inventor: John Holdorf, Corvallis, OR (US)

(21) Appl. No.: 13/135,843

(22) Filed: Jul. 15, 2011

(51) Int. Cl. A61H 15/00

(52) U.S. Cl. 601/128

(57) ABSTRACT

A method and apparatus for massage of human appendages is disclosed. The apparatus includes handles, two manifolds penetrated by a plurality of cord chases, cords attached to the handles and looping through a cord chase in the first manifold to a cord chase in the second manifold and returning through another cord chase through said first manifold to the handles. A plurality of beads is disposed on the cords in the loop. As the handles are pulled, tension on the cords causes the loop to diminish in size and provide massaging pressure to the appendage.

The present invention relates to a method and apparatus for appendage massage and more particularly to a human powered massage apparatus and method for the massage of legs and arms.

### BACKGROUND

Some of the maladies afflicting humans are those of lymph edema in the extremities of the body, particularly in the lower leg or arm. Edema is the chronic abnormal accumulation of fluid in interstitial tissue and is characterized by swelling of an individual's extremity. This swelling results from a combination of passive venous congestion and salt and water retention. Edema can result from the abnormal function or other impairment of the lymph vessels or arise in response to injury or post-operatively, when fluid is released as a result of inflammation and other mechanisms. This condition is, at the least, uncomfortable and oftentimes painful and debilitating.

In order to reduce the discomfort, manual massage techniques and mechanical devices involving pneumatic or other fluid compression mechanism have been devised to aid in the displacement of body fluids from the extremities. Usually the devices are used, and the manual massage is accomplished, under medical supervision, thereby making immediate relief relatively difficult to obtain. Moreover, the mechanical devices in general use are known to be expensive, again making immediate relief difficult.

One example of an edema reduction medical device has been disclosed in U.S. Patent Application Publication No. 2007/0282230 by Valderrabano et al., in which an orthopedic device is fitted around a limb of a patient and fluid bladders are operated to massage lymph fluid in the lymphatic vessels in a direction toward the patient's heart. Other devices employ gas to inflate closed chambers (U.S. Pat. No. 5,007,411 to Dye) or mechanically contracting sleeves (U.S. Pat. No. 5,179,941 to Siemssen et al.) to treat patients' extremities.

In each instance, the apparatus is a relatively complicated device requiring an external driving or compressing mechanism. Even a simple device for use by non-medically trained individuals, such as that disclosed in U.S. Patent Application Publication No. 2008/0039752 by Rousso, employs batteries to power electric motors. Also, massaging devices such as that described in U.S. Pat. No. 3,957,039 to Ehren are not known to be effective in providing relief from edema-related discomfort.

Therefore it would be a substantial benefit to those suffering from lymph edema to have a simple device that would enable them to reduce their discomfort at their convenience without extensive medical training or the presence of medical personnel.

### BRIEF DESCRIPTION OF THE DRAWINGS

FIG. 1 is diagram of an apparatus for appendage massage, which may employ the present invention.

FIG. 2 is a first cross section of a manifold of the apparatus of FIG. 1.

FIG. 3 is a second cross section of a manifold of the apparatus of FIG. 1.

FIG. 4 is an illustration of an apparatus, such as that of FIG. 1, in operating position on a user's leg.

FIG. 5 is an illustration of an apparatus for massage in operating position on a user's arm.

FIG. 6 is an illustration of the apparatus of FIG. 5 viewed from one end of the apparatus.

### DETAILED DESCRIPTION OF THE EMBODIMENTS

The present invention is directed toward a device and method for its use that enables those suffering from lymph edema to reduce their discomfort at their convenience without extensive medical training or the presence of medical personnel.

One aspect of the present invention includes an apparatus for human appendages and includes a handle, first and second manifolds penetrated by a plurality of cord chases, a cord attached to the handle, and first and second pluralities of beads or beads. One embodiment of the present invention employs beads to contact the limb of the user. Rollers, which may be thought of as beads that are not substantially round, rather, having an elongation in the direction of the axis of a through-hole, may be employed in place of round beads without affecting the scope of the claimed present invention. The cord loops through a first cord chase of the first manifold to a second cord chase through the second manifold and returns through a third cord chase through the first manifold, whereupon it attached to the handle. The first plurality of beads is disposed on the cord between the first manifold first cord chase and the second manifold second cord chase and the second plurality of beads is disposed on the cord segment between the second manifold first cord chase and the first manifold second cord chase. The first and second pluralities of beads are positioned to encircle the appendage whereby a force applied to the handle to pull the first and second pluralities of beads along the appendage causes tension in the first cord.

Another aspect includes a method of reducing discomfort by selective massage of a human appendage by a massage apparatus. A cord is looped between two manifolds that have a plurality of cord chases extending through the manifolds. The loop encircles the appendage as a girdle. The method includes tensioning the cord when at least one handle to which the cord is affixed is pulled in a direction toward a location of attachment of the appendage to a body, that is, the trunk of the body, and reducing a girdle dimension by the cord tensioning. The method includes rolling a plurality of beads against the appendage, the beads being disposed on the cord in the girdle.

Another aspect includes a method of discomfort reduction by massage of a human appendage. The appendage is encircled with first and second pluralities of beads, which are disposed on a cord attached to a handle and looped between two manifolds. The manifolds have a plurality of cord chases extending through the manifolds whereby the cord is free to slip through the manifolds. Pulling on the handle in a direction toward a location of attachment of the appendage to a body causes tension in the cord and causes the first and second plurality of beads to rotate about the cord and against the appendage.

Another aspect of the present invention includes an apparatus for human appendages that includes at least one elongate handle having a proximal end and a distal end. The proximal end is adapted to be grasped by hand and the distal end secures a cord segment. The apparatus further includes a first manifold and a second manifold, each manifold having a length dimension value greater than a width dimension value. The first manifold includes a first cord chase penetrating the first manifold at a first location and exiting the first manifold at a second location. The first manifold also includes a second cord chase penetrating the first manifold at a third location displaced from the first location in both the width dimension and the length dimension and exiting the first manifold at a fourth location displaced from the second location in both the width dimension and the length dimension. The second manifold includes a first cord chase, the second manifold first cord chase penetrating the second manifold at a second manifold fifth location and exiting the second manifold at a second manifold sixth location. The cord segment forms a loop and is secured at the elongate handle. The cord segment enters the first manifold first cord chase at the first location, exits the first manifold first cord chase at the second location, enters the second manifold first cord chase at the fifth location, exits the second manifold first cord chase at the sixth location, enters the first manifold second cord chase at the third location, exits the first manifold second cord chase at the fourth location, and is secured at the at least one elongate handle. The apparatus further includes a first plurality of beads disposed on the cord segment between the first manifold first cord chase second location and the second manifold cord first cord chase fifth location and further includes a second plurality of beads disposed on the cord segment between the second manifold first cord chase sixth location and the first manifold second cord chase third location.

A strictly mechanical device for the purpose of reducing discomfort in the lower leg and ankle areas, and in the arm, is powered solely by the user. A representation of an embodiment of the present invention is shown in FIG. 1. A girdle 101 of beads 103 strung onto a plurality of cords 105, 107, 109, 111 that, in operation, are caused to encircle a user's limb. For ease of understanding, beads 103 are shown only on cord 105, and only six beads are strung on cord 105 in one embodiment, although the number can be more or fewer depending upon the length of each roller and the limb that is the primary target of the device. In one embodiment, the beads are 2.5 cm (1 inch) round beads with a 0.55 cm ( 7/32 inch) ID hole. In one embodiment four cords are used, but more or fewer cords may be employed and the manifold perforated accordingly.

A cord 105 has both ends affixed to a handle 113, in one embodiment, by means of a spring loaded cord keeper 115, but other securing mechanisms can be used, for example, knotting or mechanical locking or chemical adhesives. Cord 105 is routed from the handle 113 to a cylindrical manifold 117, wherein cord 105 is slidably routed through a low-friction chase 119 to the limb-encircling girdle 101 area. Beads 103 are placed on cord 105 in the girdle area (in one embodiment, three beads are so placed) and the cord 105 is routed to another manifold 121. Manifold 121 is also supplied with a low-friction chase 123, through which cord 105 is routed. From there, cord 105 is strung with three beads (in one embodiment) to complete the encircling girdle 101, and returned to manifold 117 to pass through another low-friction chase 125 to be secured at handle 113.

In a similar fashion, cord 109 is secured to handle 127, routed through low-friction chase 129 in manifold 121, strung with beads (not illustrated) an one side of girdle 101, routed through low-friction chase 131 in manifold 117, strung with beads (not illustrated) on the other side of girdle 101, routed through low-friction chase 133 in manifold 121, and secured to handle 127. It is to be observed that cord 109 is routed adjacent cord 105 but secured to handle 127, while cord 105 is secured to handle 113.

Cord 107 is disposed adjacent cord 109, secured to handle 113, and routed in a manner similar to cord 105. Cord 107 also, like cord 105, is strung with beads in the girdle 101 area. Cord 111 is disposed adjacent cord 107, secured to handle 127, and routed in a manner similar to cord 109. Cord 111, like cord 109, is strung with beads in the girdle 101 area.

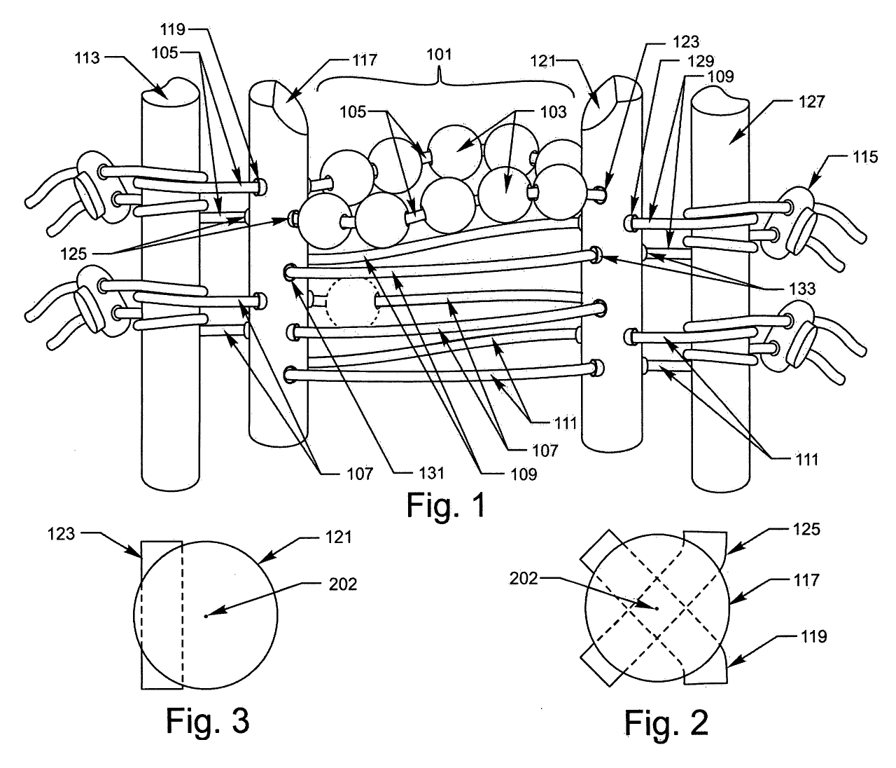

A cross sectional view through manifold 117 at the location near chase 119 and chase 125 is shown in FIG. 2. Manifold 117 in one embodiment is a cylindrical prismatic body having a length dimension and a width dimension, wherein the length dimension value is greater than the width dimension value. In one embodiment the manifold is of cylindrical shape and is 14.9 cm (5⅞ inches) long and 3.2 cm (1¼ inch) in width. In the case of a cylindrical body, the width equates to the diameter of the cylinder. Other solid shapes may be used as a manifold body, depending upon aesthetics and ease of the cords sliding through chases penetrating the manifold. In an alternate embodiment, the manifold length is increased by 1.9 cm (¾ inch) on both ends to reduce interaction with the user's leg and to aid in the manifold-cord assembly. In FIG. 2, both chases pass through the center axis 202 of the manifold 117. From the viewpoint of the handle 113, chase 119 enters manifold 117 from a location that is disposed approximately 1.3 cm (½ inch) from one end of the manifold 117 and parallel to the plane of the circumference of the cylindrical manifold 117. Chase 119 exits manifold 117 at a location that is 180° around the circumference of the manifold 117 from the entry location of chase 119. Also from the viewpoint of the handle 113, chase 125 enters manifold 117 from a location disposed approximately 2.5 cm (1 inch) from the one end of the manifold, parallel to the plane of the circumference of the manifold 117, and rotated 90° around the circumference of the manifold from the location of entry of chase 119. Chase 125 exits manifold 117 at a location that is 180° around the circumference of the manifold 117 from the entry location of chase 125. In one embodiment, the exit orifices of chase 119 and chase 125 facing the girdle are angled 45° from the diameter, and in the plane of the circumference of manifold 117.

FIG. 3 is a cross sectional view through manifold 121 at the position of chase 123. Chase 123 enters and exits manifold 121 at locations disposed approximately 4.5 cm (1¾ inch) from the one end of manifold 121 and each chase 123 entry and exit location are located in the plane of the circumference of manifold 121. However, chase 123 does not run through the axis 202 of manifold 121; rather, chase 123 is displaced from the axis 202 in a direction toward the girdle 101 area. Thus, manifold 121 is perforated by chases, one set of chases crossing (but not intersecting) each other through the manifold axis and paired to accept a cord running from handle 113, through manifold 117, through the girdle 101, through manifold 121, through the girdle 101, and back through manifold 117 to the handle 113. Another chase accepts a cord coming from handle 127, through manifold 121, through the girdle 101, through manifold 117, through the girdle 101, and through manifold 121 to handle 127. As can be perceived from FIG. 1, manifold 117 is similarly perforated with chase pairs for cords terminated at handle 113 and perforated with chases for cords terminated at handle 127.

The advantage of arranging the handles, manifolds, beads, and cords as described above is that when a limb is present in the girdle 101 and the handles are pulled by the user, the cords tighten and the girdle area is reduced. When the user ceases to pull on the handles, the cords loosen and the girdle area relaxes, provided of course that no impediment is encountered in the movement of the girdle. Since the user is the power source for the motion of the described apparatus, the user is able to adjust the apparatus to overcome impediments.

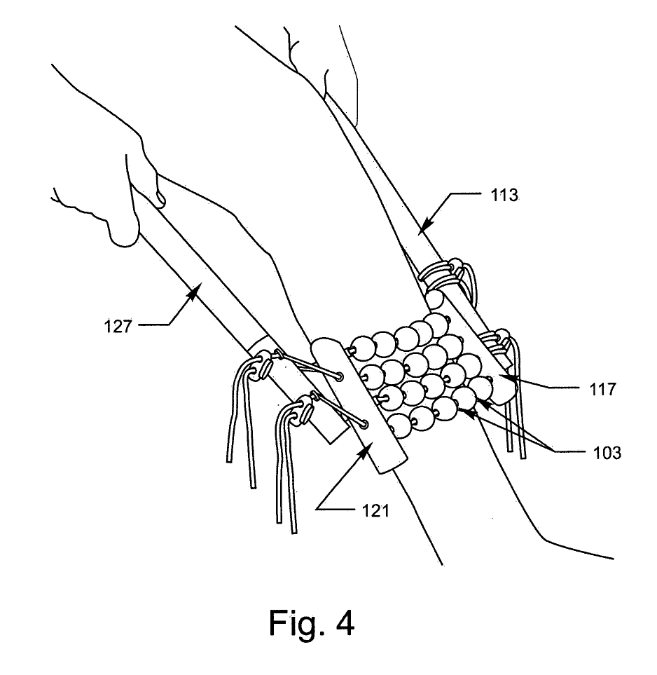

FIG. 4 is an illustration of one embodiment of an apparatus in use for a user's leg. The user's leg is inserted in the girdle with beads 103 and their supporting cords disposed on one side of the leg and beads and their supporting cords on the opposite side of the leg (but not visible in FIG. 4). Handles 127 and 113 are grasped by hand at the end of the handles that is opposite the end at which the cords leading to the manifolds 117, 121 and girdle are located. In one embodiment, the handles are cylindrical prismatic structures that are approximately 40 cm (15¾ inches) long and 2.5 cm (1 inch) in diameter, but can vary with the specific needs of the user. In one embodiment, an additional 5 cm (2 inches) are added beyond the area of cord attachment so that tangling of the cords is reduced. Of course, the handles can be hollow or solid and of any cross sectional shape that is aesthetically pleasing and structurally sound.

In one embodiment, the handles 127 and 113 are formed of wood, with handgrips such as those used for bicycle handlebars. However, other materials such as injected molded plastic with textured integrated grips or hollow tubing with wrapped grips, among others, are suitable for this application. The manifolds 117 and 121 are formed of wood but may also be of other materials. The chases are sections of plastic tubing of PEX or similar plastic materials, which provide a low-friction surface upon which the cords may easily slide. The chases are cut and inserted into holes formed in the manifolds. The beads are constructed of wood or injection molded plastic or similar materials may also be used. As an alternative, rollers may be used in place of beads. Such rollers are 1.0 cm (⅜ inch) in OD and 2.8 cm (1⅛ inch) long, with a hole having in ID of 0.55 cm ( 7/32 inch) running the axis of the rollers. The cords are cut from flat hollow woven nylon ribbon—smooth and slippery—and are approximately 60 cm (23½ inch) long and 0.6 cm (¼ inch) wide.

The user is given the following instructions for use:
1. Put a compression stocking such as one made by Activa™, available from FLA Orthopedics, Rytherford College, NC, on the leg you want to massage.
2. Grasp the two handles of the apparatus
3. Hold them up and pull them apart to make sure none of the four cords between the handle and the (short) manifold on either side is tangled. Untangle it if it is.
4. Lightly stretch the handles apart and lay the manifold and strings down in front of your foot, and lay down the long handles to the sides of your foot.
5. Hold on to the handles and slip your toes and then your foot between the two manifolds (on either side), under the top four rows of beads, and over the bottom four rows of beads.
6. Grasp the handles and pull the unit under your heel and up to the top of your ankle. (If the unit does not clear your ankle it is probably tangled.)
7. Pull the handles apart to tighten the cords. Shift the unit back and forth until the beads fall into place.
8. Pull up one handle and then pull up the other handle, alternating from one to the other until you get above the thickest part of your lower leg.
9. Then stretch the handles apart again to tighten the cords again, and repeat the alternating pulls. Retighten again if the cords get loose.
10. Stop just below your knee.
11. Relax the tension on the handles to loosen and allow the unit slide down to the ankle.
12. Repeat steps 7-11 for about 10 minutes or until you feel more comfortable.

Calibration
Occasionally the device will require re-calibration to ensure that it is working. This entails laying out the device on a table or on the floor so that the handles and manifolds are all parallel with each other and that the cords are all squared to an imaginary line tangent to the distal ends of the two manifolds and that the cords are all horizontal and taut. If not then the ‘slack’ ones will require shortening or else the taut ones loosening until the entire unit is re-calibrated.

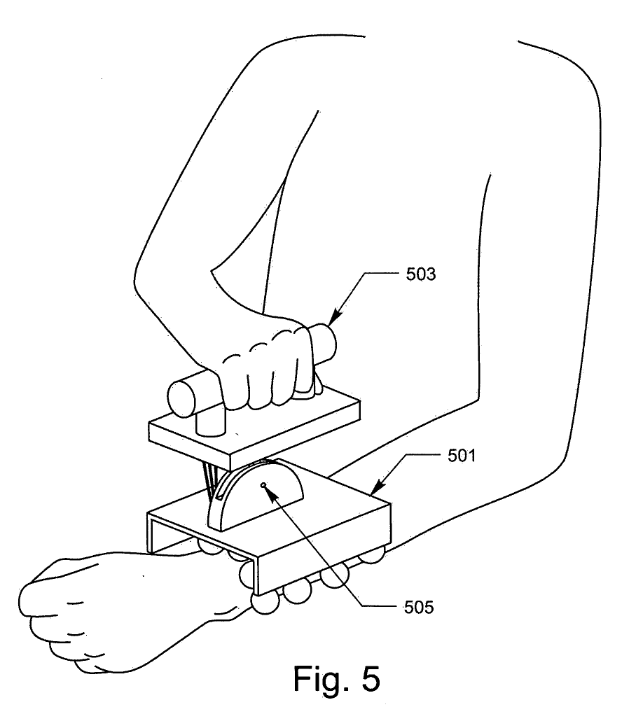

FIG. 5 is an illustration of one embodiment of an apparatus for use on an arm. A rectangular box-like housing 501, open at each end and one side, partially encloses four courses of beads strung on cords disposed in loops substantially parallel to the open ends. A moveable handle 503 is attached via a rod to a pivot point 505 in a manner that enables the handle 503 to rotate about the pivot point 505 and provide a translational force to the housing 501. The cords are attached to one end of the handle, displaced from the pivot point 505 in the direction of the hand, when in use. An arm to be massaged is inserted through the girdle of cord loops and the handle is pulled in the direction away from the hand and toward the user's body trunk. As the handle 503 is pulled, the housing 501 is moved away from the hand and the cords are caused to tighten as the handle 503 rotates about the pivot point 505. When the handle 503 is pushed toward the hand, the cords loosen and the housing 501 is moved toward the hand.

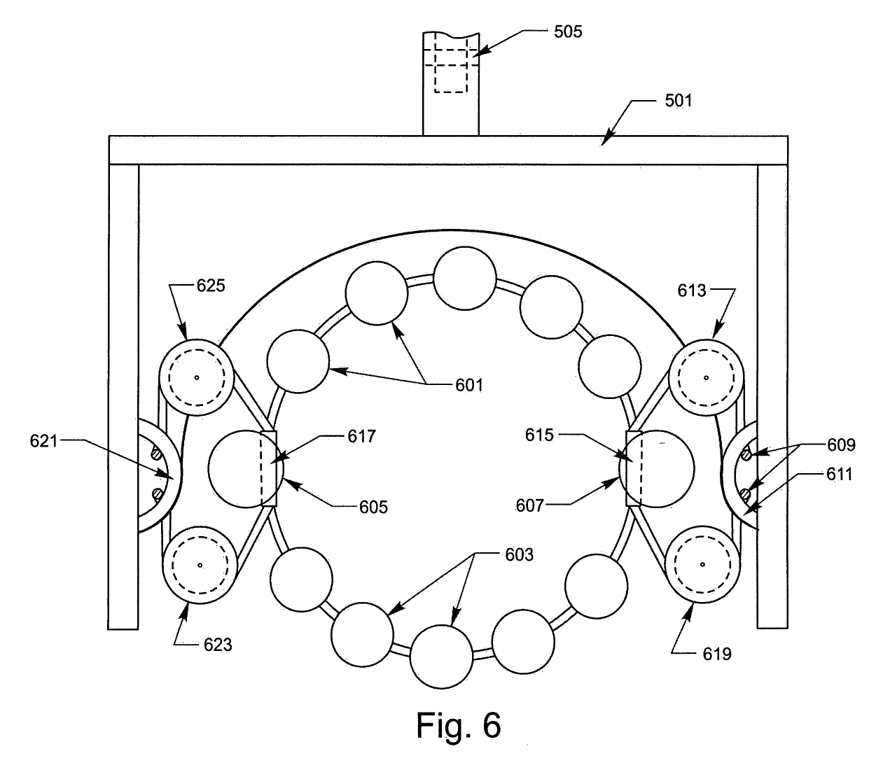

A view of the arm massager apparatus is shown in the illustration of FIG. 6. Disposed within the open housing 501 of an embodiment are four cord loops to girdle the arm, only one girdle loop is shown for clarity. Two sets of rolling beads 601, 603 are disposed on the illustrated cord loop and separated from each other by two manifolds 605, 607. The cords are secured to the handle 503 by spring-loaded keepers, or knotted, as described above. Two saddle chases 611 and 621, shaped like half-toruses, or half-donuts, made of wood or plastic, and four rotatable spindles 613, 619, 623, and 625 are attached to the housing 501. The path of one exemplary cord 609 extends from the handle 503 to saddle chase 611, where the cord 609 is routed over the inside donut-half of saddle chase 611 so that it can change direction by 90°, from parallel to the user's arm to perpendicular to the user's arm. The cord 609 is then routed by way of spindle 613, having an axis attached to housing 501, to manifold 607. At manifold 607 cord 609 passes through a low-friction cord chase 615 running through manifold 607. From chase 615, cord 609 is routed through five beads 603, in one embodiment, then to manifold 605 where cord 609 passes through a low friction cord chase 617, which penetrates manifold 605. From chase 617, cord 609 is routed through five beads 601 then to another low friction chase through manifold 607 to spindle 619. From spindle 619, cord 609 is routed to saddle chase 611 to change direction to parallel the user's arm and then to handle 503. A second cord (not shown) of the four cords is routed in an opposite direction from cord 609. That is, another cord is routed from handle 503 to saddle chase 621, to spindle 623, through manifold 605, through one set of beads, through manifold 607, through another set of beads, through manifold 605, to spindle 625 and saddle chase 621, and returned to handle 503. Two additional cords, in one embodiment, are similarly disposed but separated in a direction along the user's arm. Similar to the manifolds used in the leg massager embodiment, manifolds 605 and 607 are perforated cylindrical elements that are not attached to the frame 501. Manifolds 605, 607 are free to move as the girdle of beads is contracted and expanded with pulling and pushing movements of the handle.

Thus, an apparatus and method has been shown and described which reduces the discomfort of edema in a user's legs or arms by causing beads to be drawn across the limb of the user by that user in one direction while relaxing roller pressure in the opposite direction.

I claim:

1. A massage apparatus for human appendages, comprising:
a handle;
first and second manifolds penetrated by a plurality of cord chases;
a cord attached to said handle, routed through a first cord chase of said first manifold to a second cord chase through said second manifold, returning through a third cord chase through said first manifold, and attached to said handle; and
a first plurality of beads disposed on said cord between said first manifold first cord chase and said second manifold second cord chase and a second plurality of beads disposed on said cord segment between said second manifold first cord chase and said first manifold second cord chase, said first and second pluralities of beads positioned to encircle the appendage whereby a force applied to said handle to pull said first and second pluralities of beads along the appendage causes tension in said cord.

2. The massage apparatus of claim 1 wherein said first manifold further comprises a length dimension value greater than a width dimension value and said first cord chase penetrating said first manifold at a first location and exiting said first manifold at a second location and said third cord chase penetrating said first manifold at a third location displaced from said first location in both said width dimension and said length dimension and exiting said first manifold at a fourth location displaced from said second location in both said width dimension and said length dimension.

3. The massage apparatus of claim 2 wherein said second manifold further comprises said second cord chase penetrating said second manifold at a second manifold first location and exiting said second manifold at a second manifold second location.

4. The massage apparatus of claim 2 wherein said first and third cord chases extend through said width dimension of said first manifold for each of said first and third cord chases and extend through a center axis of said first manifold.

5. The massage apparatus of claim 3 wherein said manifold is a cylindrical prismatic body and wherein said massage apparatus further comprises a second cord chase extending through said second manifold parallel to a diameter of said manifold but not extending through an axis of said second manifold.

6. The massage apparatus of claim 1 further comprising a second handle and a second cord attached to said second handle, said second cord routed through a fourth cord chase penetrating said second manifold, to a fifth cord chase through said first manifold, returning through a sixth cord chase through said second manifold, and attached to said handle, and a third plurality of beads disposed on said second cord between said second manifold fourth cord chase and said first manifold fifth cord chase and a fourth plurality of beads disposed on said second cord segment between said first manifold fifth cord chase and said second manifold sixth cord chase.

7. The massage apparatus of claim 1 further comprising a saddle chase through which said cord changes direction between said attachment of said cored to said handle and said routing through said first cord chase of said first manifold.

8. A method of selective massage of a human appendage, comprising the steps of:
tensioning a cord routed between two manifolds having a plurality of cord chases extending through said manifolds, said routed cord encircling the appendage as a girdle, when at least one handle to which the cord is affixed is pulled in a direction toward a trunk of a body;
reducing a girdle dimension by said cord tensioning; and
rolling a plurality of beads against the appendage, said beads disposed on said cord in said girdle.

9. The method of claim 8 further comprising the step of relaxing said cord tension and increasing said girdle dimension.

10. A method of selective massage of a human appendage, comprising the steps of:
encircling the appendage with a first plurality of beads and a second plurality of beads disposed on a cord attached to a handle and looped between two manifolds having a plurality of cord chases extending through said manifolds, whereby said cord is free to slip through said manifolds; and
pulling on said handle in a direction toward a location of attachment of the appendage to a body to cause tension in said cord and to cause said first and second plurality of beads to rotate about said cord and against the appendage.

11. A massage apparatus for human appendages, comprising:
at least one elongate handle having a proximal end and a distal end, said proximal end adapted to be grasped by hand and said distal end securing a cord segment;
a first manifold and a second manifold, each manifold having a length dimension value greater than a width dimension value, said first manifold including a first cord chase penetrating said first manifold at a first location and exiting said first manifold at a second location and a second cord chase penetrating said first manifold at a third location displaced from said first location in both said width dimension and said length dimension and exiting said first manifold at a fourth location displaced from said second location in both said width dimension and said length dimension;
said second manifold including a first cord chase, said second manifold first cord chase penetrating said second manifold at a second manifold fifth location and exiting said second manifold at a second manifold sixth location;
said cord segment forming a loop, said first cord segment secured at said at least one elongate handle, entering said first manifold first cord chase at said first location, exiting said first manifold first cord chase at said second location, entering said second manifold first cord chase at said fifth location, exiting said second manifold first cord chase at said sixth location, entering said first manifold second cord chase at said third location, exiting said first manifold second cord chase at said fourth location, and secured at said at least one elongate handle; and
a first plurality of beads disposed on said cord segment between said first manifold first cord chase second location and said second manifold cord first cord chase fifth location and a second plurality of beads disposed on said cord segment between said second manifold first cord chase sixth location and said first manifold second cord chase third location.

12. The massage apparatus of claim 11 further comprising:
a second elongate handle, said second elongate handle having a proximal end and a distal end, said proximal end adapted to be grasped by hand and said distal end securing a second cord segment;
a second manifold second cord chase penetrating said second manifold at a seventh location and exiting said second manifold at an eighth location and a second manifold third cord chase penetrating said second manifold at a ninth location displaced from said seventh location and exiting said second manifold at a tenth location displaced from said eighth location;
a first manifold third cord chase said first manifold third cord chase penetrating said first manifold at a first manifold eleventh location and exiting said first manifold at a first manifold twelfth location;
said second cord segment forming a loop, said second cord segment secured at said second elongate handle, entering said second manifold second cord chase at said seventh location, exiting said second manifold second cord chase at said eighth location, entering said first manifold third cord chase at said ninth location, exiting said first manifold third cord chase at said tenth location, entering said second manifold third cord chase at said eleventh location, exiting said second manifold third cord chase at said twelfth location, and secured at said second elongate handle; and
a third plurality of beads disposed on said second cord segment between said second manifold second cord chase eighth location and said first manifold third cord chase ninth location and a fourth plurality of beads disposed on said second cord segment between said first manifold third cord chase tenth location and said second manifold third cord chase eleventh location.

13. The massage apparatus of claim 11 further comprising two cord chases extending through said width dimension of said first manifold for each of said at least two cord segments.

14. The massage apparatus of claim 13 wherein said two cord chases further comprise said two cord chases extending through a center axis of said manifold.

15. The massage apparatus of claim 13 wherein said manifold is a cylindrical prismatic body and wherein said massage apparatus further comprises a third cord chase extending through said manifold parallel to a diameter of said manifold but not extending through an axis of said manifold.

16. The massage apparatus of claim 11 further comprising a saddle chase, said saddle chase shaped as a half-torus through which said cord segment is routed between said at least one elongate handle and said first manifold first cord chase.
